(19) United States
(12) Patent Application Publication
(10) Pub. No.: US 2012/0054612 A1
(43) Pub. Date: Mar. 1, 2012

(54) METHOD AND APPARATUS FOR PLAYING CONTENTS

(75) Inventors: Il Geun BOK, Seoul (KR); Min Kyung KIM, Seoul (KR); Myoung Hwan HAN, Seoul (KR); Tae Yeon KIM, Seoul (KR)

(73) Assignee: SAMSUNG ELECTRONICS CO., LTD., Gyeonggi-Do (KR)

(21) Appl. No.: 13/218,892

(22) Filed: Aug. 26, 2011

(30) Foreign Application Priority Data
Aug. 27, 2010 (KR) 10-2010-0083638

(51) Int. Cl. G06F 3/048

(52) U.S. Cl. 715/716

(57) ABSTRACT

A method and an apparatus for playing contents are provided. The apparatus includes: a touch screen playing contents on a screen and detecting a touch input through the screen; and a processor sensing a touch event occurring on the touch screen during a playback of the contents, displaying a progressive bar having information regarding running time of the contents played on the touch screen to overlap with the contents in response to the touch event, and controlling display of a mark at a location of the progressive bar corresponding to an occurrence time point of the touch event.

### CLAIM OF PRIORITY

This application claims the benefit under 35 U.S.C. §119 from a Korean patent application filed in the Korean Intellectual Property Office on Aug. 27, 2010 and assigned Serial No. 10-2010-0083638, of which the entire disclosure is hereby incorporated by reference in its entirety.

### BACKGROUND OF THE INVENTION

1. Field of the Invention

The present invention relates to a method and an apparatus for playing contents, and more particularly, to a method for controlling a playback speed and a playback location of contents played on a touch screen, and an apparatus thereof.

2. Description of the Related Art

A touch screen enables a user to input various commands. If a finger or an object such as a stylus pen contacts a specific character, a graphical user interface (GUI) object, or a certain location, the touch screen recognizes the contacted location and process a corresponding operation.

In recent years, with miniaturization of an electronic device such as a mobile communication terminal or a computer, a touch screen has been widely used as a preferred choice as an input device.

### SUMMARY OF THE INVENTION

The present invention provides an improved scheme in navigating content during a replay mode for enhancing a viewing experience.

In accordance with an aspect of the present invention, a method for replaying contents in a portable electronic device having a touch screen includes: sensing a touch event occurring on the touch screen during a playback of the contents; displaying a progressive bar having information regarding a running time of the contents currently displayed on the touch screen in response to the touch event; and determining a location on the progressive bar corresponding to the currently displayed contents when the touch event occurs and displaying an indicator at the determined location.

In accordance with another aspect of the present invention, an apparatus for playing contents includes: a touch screen playing the contents on a screen and detecting a touch input thereon; and a processor sensing a touch event occurring on the touch screen during a playback of the contents, displaying a progressive bar having information regarding running time of the contents played on the touch screen in response to the touch event, and controlling a display of an indicator at a location of the progressive bar corresponding to an occurrence time point of the touch event.

An embodiment of the present invention may conveniently control the playback speed and the playback location of contents through a touch screen.

### BRIEF DESCRIPTION OF THE DRAWINGS

The above, features and advantages of the present invention will be more apparent from the following detailed description in conjunction with the accompanying drawings, in which:

FIG. 1 is a block diagram illustrating a configuration of a portable electronic device according to an exemplary embodiment of the present invention;

FIG. 2 is a view illustrating a Graphic User Interface (GUI) screen when dragging occurs during a playback of contents on a touch screen of a portable electronic device according to an exemplary embodiment of the present invention;

FIG. 3 is a view illustrating a GUI screen when a certain gesture occurs during a playback of contents on a touch screen of a portable electronic device according to another embodiment of the present invention;

FIG. 4 is a view illustrating a Graphic User Interface (GUI) screen when tap operation and dragging occur in a displayed state of a progressive bar on a touch screen of a portable electronic device according to yet another embodiment of the present invention;

FIG. 5 is a flowchart illustrating a method for processing gesture input during a playback of contents according to an embodiment of the present invention;

FIG. 6 is a flowchart illustrating a method for processing dragging during a playback of contents according to another embodiment of the present invention; and

FIG. 7 is a flowchart illustrating a method for processing tag operation and dragging occurring on a progressive bar according to still another embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

Further, a singular form used in the specification and claims attached includes a plural form unless it is designated in contexts clearly and separately. In addition, as used herein, it will be appreciated that the term “and/or” refers to all possible combinations of at least one listed relation item.

As used herein, the terms ‘touch input’, ‘gesture’, ‘certain gesture’, ‘dragging’, and ‘tap’ refer to a touch event occurring on a touch screen by a user.

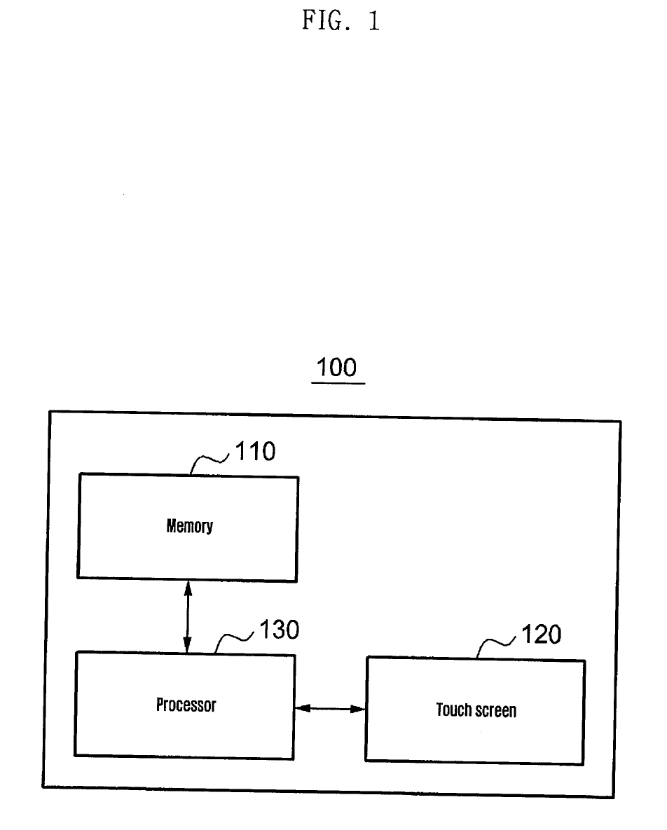

FIG. 1 is a block diagram illustrating a configuration of a portable electronic device according to an exemplary embodiment of the present invention. Referring to FIG. 1, a portable electronic device 100 may include a memory 110, a touch screen 120, and a processor 130.

The memory 110 stores programs and/or data. For example, the memory 110 may include a Read Only Memory (ROM), a Random Access Memory (RAM), a flash memory, a hard disk, an optical disc, or a non-volatile solid state memory.

In an embodiment, the memory 110 may store commands and/or soft programs for implementing a method according to an exemplary embodiment. For example, the memory 110 stores at least one program configured to be executed by a processor 130. The program may include a command for sensing a certain gesture occurring on the touch screen during a playback of the contents, a command for displaying a progressive bar having information about a running time of the contents played on the touch screen to overlap the contents in response to the certain gesture, and a command for displaying a mark at a location of the progressive bar corresponding to an occurrence time point of the certain gesture.

In another embodiment, the memory 110 may include at least one program which includes a command sensing a touch occurring on the touch screen during a playback of the contents, a command displaying a progressive bar having information regarding a running time of the contents played on the touch screen to overlap with the contents in response to the touch, and a command playing the contents while skipping them corresponding to a dragging direction and speed when such a dragging motion is sensed, and playing the contents at a normal speed when the dragging operation is terminated.

In yet another embodiment, the memory 110 stores at least one program configured to be executed by the processor 130. The program may include a command sensing a touch gesture occurring on a fist display region of the touch screen during a playback of time-based contents, a command displaying a progressive bar indicating a current played location of the contents of a second display region of the touch screen in response to the touch gesture on a second display region of the touch screen, and a command displaying a mark on a location of the progressive bar corresponding to an occurrence time point of the touch gesture.

The touch screen 120 serves as an input interface and output interface between the portable electronic device 100 and a user. The touch screen may sense the touch input and output coordinates of a location in which the touch is sensed by a processor. Further, the touch screen may display visible output on a screen. The visible output may include graphic, texts, icons, videos, and a combination thereof (generally refer to “graphic”). The touch screen 120 may play contents on a screen. The contents may include moving image files, still image files, music files, E-book files, and a combination thereof. In addition, the contents are configured by a plurality of frames, and may include time-based contents having frames that are changed and played according to a time. For example, the time-based contents may include moving image files, music files, and slide show files configured by still images. Further, to play the contents on the touch screen is to display the contents on the touch screen. When the contents are music files, to play the contents on the touch screen may be to display a played state of the music files.

In an embodiment of the present invention, the touch screen 120 recognizes a location and/or the size of an occurrence point of a touch as well as the touch input. If a touch input is occurs, the touch screen 120 outputs coordinates of the occurrence point of a touch to a processor 130. Here, the coordinates may be (x, y) coordinates or polar coordinates. Further, the touch screen 120 may display data under the control of the processor 130 or may display an operation state and/or plural information with icons and/or characters. In an exemplary embodiment, the touch screen may display guide messages and a progressive bar for providing information to a user. Further, the touch screen 120 senses a tap and output an occurrence location of the tap to the processor 130. Moreover, the touch screen may sense a dragging motion and output an occurrence location and moving speed of the dragging motion to the processor 130.

The processor 130 may execute various software programs and/or command sets stored in the memory 110 to perform various function and process data for the device 100.

For example, the processor 130 senses a certain gesture occurring in the touch screen during a playback of contents. The processor 130 displays a progressive bar having information about a running time of the contents played on the touch screen to overlap the contents in response to the certain gesture. The processor 130 may control the device 100 to display a mark at a location of the progressive bar corresponding to an occurrence time point of the certain gesture. Time delay may be caused until the processor 130 receives, processes, and recognizes a gesture occurring on the touch screen.

Accordingly, a location of a progressive bar corresponding to an occurrence time point a first gesture may differ from that of a progressive bar displaying a real mark. As such, the processor 130 may compensate this delay by displaying the progressive bar in front of the location when the gesture occurred by a predetermined time amount.

Further, the processor 130 control an indicator indicating a current played location of the contents on the progressive bar, and controls the indicator to be move on the progressive bar corresponding to a playback of the contents. When a touch is sensed on the progressive bar and the touch maintains for a predetermined time period, the processor 130 may increase the playback speed of the contents as the touch is maintained longer than the predetermined time period. The contents are configured by a plurality of frames, and the processor sequentially plays the plurality of frames when playing the contents at a normal speed. The processor 130 may rapidly play the contents while skipping a part of the plurality of frames. Accordingly, playback speed of the contents may become higher. For example, when the contents are configured by 30 frames, the processor 130 displays all of the 30 frames in one second during a normal playback. The processor 130 skips 15 frames of 30 frames for one second but displays only remaining 14 frames while playing the contents at a double speed. The processor 130 skips 20 frames of 30 frames for one second but displays only remaining 10 frames while playing the contents at a triple speed. Meanwhile, the processor may display 60 frames on a touch screen for one second to slowly play the contents. As the processor 130 skips the number of frames played for one second, a playback speed may be faster and a played location may be controlled.

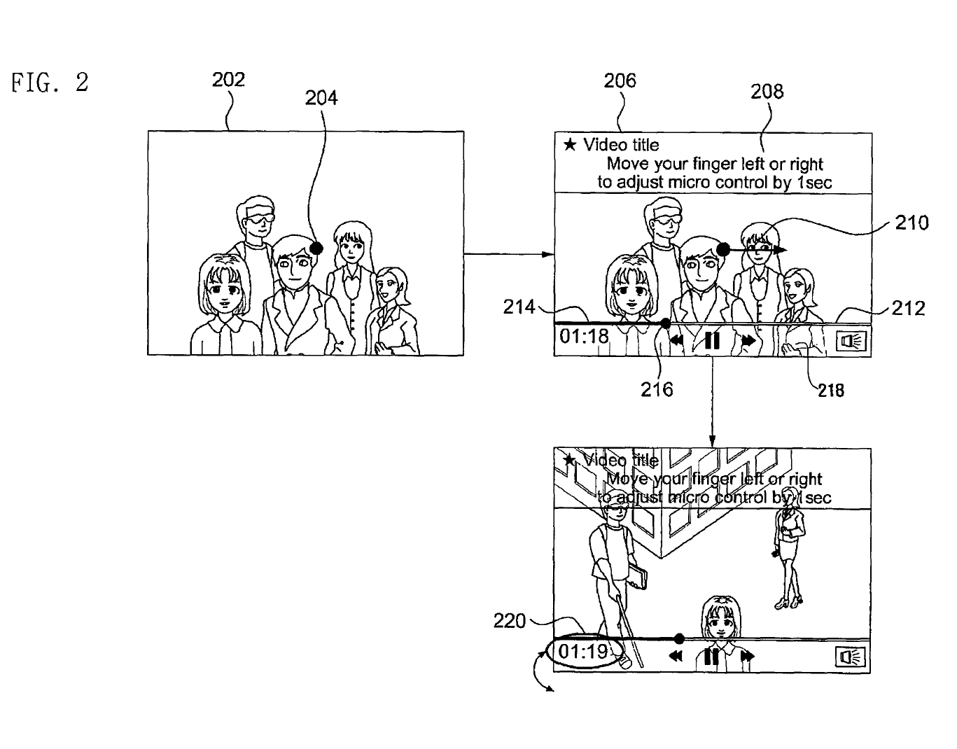

FIG. 2 is a view illustrating a Graphic User Interface (GUI) screen when dragging occurs during a playback of contents on a touch screen of a portable electronic device according to an exemplary embodiment of the present invention. Referring to FIG. 2, contents are displayed on a screen 202. The touch screen may detect a touch input through the screen 202 in a state the information of the contents is displayed on the screen 202. If a touch 204 of FIG. 2 occurs while playing the contents, the touch screen 120 outputs information regarding an occurrence location of the touch to the processor 130 of FIG. 1. Here, the location information may be coordinates of an occurrence point of the touch.

The processor 130 senses a touch occurring on the touch screen during a playback of the contents. The processor 130 displays a progressive bar 218 having information regarding a running time of the contents played on the touch screen to overlap with the contents in response to the touch.

Thereafter, if a dragging operation, the processor 130 plays the contents while skipping them corresponding to a direction and speed of dragging. If the dragging operation is terminated, the processor may control the contents to be played at a normal speed. Further, the processor 130 displays an indicator 216 indicating a current played location of the contents on the progressive bar. The processor 130 may control the indicator to be moved along the progressive bar to match the direction and speed of the dragging motion. In an alternate embodiment, the dragging operation and its corresponding function can be performed before the display of the progressive bar.

Meanwhile, if a tap input is sensed on the progressive bar, the processor 130 may control to play the contents while skipping the contents by a predetermined interval period. When a sensed location of tap is a right side of the indicator 216, the processor 130 plays the contents while forwardly skipping the content at a predetermined speed. When a sensed location of tap is a left side of the indicator 216, the processor 130 reversely plays the contents while skipping the content at a predetermined speed.

If a dragging motion is sensed on the progressive bar, the processor 130 may slowly play the contents corresponding to the dragging motion, or may play the contents faster in accordance with the dragging motion speed and direction.

The processor 130 may control the touch screen 120 to display a left part and a right part of the progressive bar based on the indicator to have a visual difference.

Further, in an alternate embodiment, the processor 130 receives the occurrence location information of a touch from the touch screen 120, and may displays a guide message 208 in response thereto. The guide message 208 may be displayed to overlap played contents 206 while the progressive bar 218 is displayed simultaneously, but may be displayed independently without the display of the progressive bar 218. After the guide message 208 displayed on a touch screen for a predetermined time period, it may be automatically disappeared thereafter.

After the display of the guide message 208, if a dragging motion is detected, the processor 130 rapidly plays the contents corresponding to a direction and speed of the dragging. If the dragging is terminated, the processor 130 plays the contents at a normal speed. If a touch 204 occurs during a playback of the contents 206, and the dragging 210 occurs based on a point of the touch, the processor 130 rapidly plays the contents 206 corresponding to a direction and/or moving speed of the dragging 210. The processor 130 rapidly plays contents while skipping a part of a plurality of frames constituting contents. When a direction of dragging is a right side, the processor 130 rapidly plays the contents in a forward direction. When the direction of the dragging is a left side, the processor 130 plays the contents rapidly and reversely. In an example shown in FIG. 2, reference numeral 220 illustrates that a playback location is changed from ‘01:18’ to ‘01:19’ due to dragging 210 after the dragging operation.

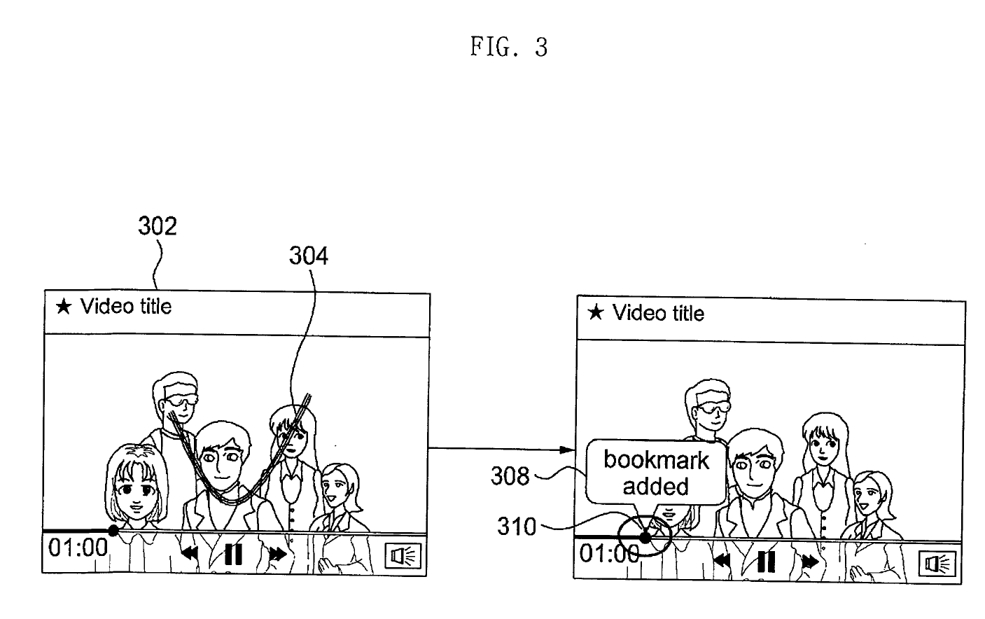

FIG. 3 is a view illustrating a GUI screen when a certain gesture occurs during a playback of contents on a touch screen of a portable electronic device according to another embodiment of the present invention.

Referring to FIG. 3, a portable electronic device having a touch screen may include a touch screen and a processor. The touch screen 120 plays contents on a screen (302) and detects a touch input through the screen. The processor 130 senses a certain gesture occurring on the touch screen during a playback of the contents. The processor displays a progressive bar having information regarding a running time of the contents played on the touch screen to overlap with the contents in response to the certain gesture. The processor 130 displays a mark 308 at a location of the progressive bar corresponding to an occurrence time point of the certain gesture. The processor 130 may display the mark in front of the location corresponding to an occurrence time point of the gesture for a predetermined time period. When an indicator 310 indicating a current played location of the contents is displayed on the progressive bar, the indicator is moved on the progressive bar corresponding to a playback of the contents. Thereafter, if a touch is sensed on the progressive bar and the touch is maintained on the bar for a predetermined time period, the processor 130 may increase a playback speed of the contents.

Further, if a tap is sensed on the progressive bar, the content is skipped in accordance with the location of the tap relative to the indicator 308. When a sensed location of the touch is a right side of the indicator, the processor plays the contents while skipping them at a predetermined interval speed. When the sensed location of the touch is a left side of the indicator, the processor 130 may reversely play the contents while skipping them. When the contents are a moving image or a music file, the processor 130 plays the contents while moving them in units of predetermined times. When the contents are an E-book, the processor 130 plays the contents while moving them in units of predetermined pages.

Referring back to FIG. 3, if a certain gesture is sensed during playback of the contents 302, the processor 130 displays a mark at a location corresponding to an occurrence time point of the certain gesture on the progressive bar. While the contents are being played, the processor 130 detects whether a certain gesture occurs on the touch screen. That is, if a gesture of “V” shape is detected on the touch screen, the processor 130 calculates which location from the full length of contents is. For example, when the full length of contents is 120 minutes and an occurrence time point of a gesture of “V” shape being a certain gesture is a location of 20 minutes, the processor 130 determines that an occurrence time point of the gesture is a ⅙ point of entire contents. The processor 130 displays a mark at a location corresponding to an occurrence time point of a gesture of “V” shape in a progressive bar. The processor 130 determines that the full length of contents corresponds to that of the progressive bar and displays a mark at a ⅙ point of the progressive bar. The processor 130 displays a guide message 308 to which the mark is added while displaying a mark 310 on the progressive bar. After the guide message 308 is displayed for a predetermined time period, it is automatically disappeared. For example, a user may designate a book mark at a certain point of contents through a gesture of “V” shape.

When the mark is added, the user touches a corresponding mark to adjust a current played location of the contents to a playback location on which the mark is displayed. That is, the marks can be used for a faster replay by skipping to a specified mark and resume the replay at a normal speed.

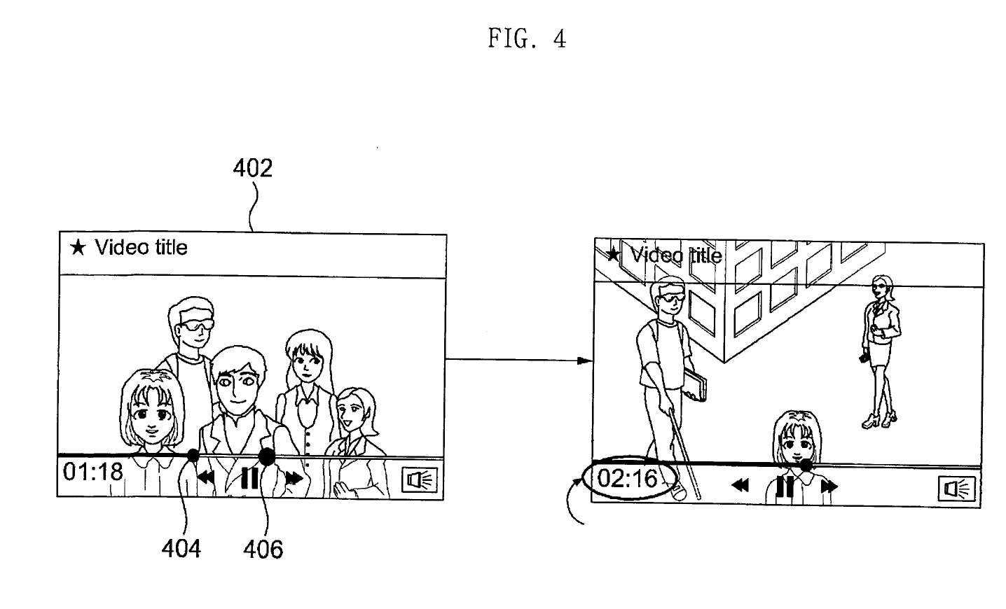

FIG. 4 is a view illustrating a Graphic User Interface (GUI) screen when a tap operation and a dragging operation occur in a displayed state of a progressive bar on a touch screen of a portable electronic device according to yet another embodiment of the present invention.

Referring to FIG. 4, if a user touches a touch screen during a playback of contents 402, a progressive bar appears. An indicator or a handler button 404 indicating a current played location of contents is displayed at a progressive bar. The GUI screen is divided into a left side and a right side in the time based on the handler button 404. A left side of the handler button 404 bar is displayed with a black color, and a right side of the handler button 404 bar is displayed with a white color. A section displayed by a black color indicates the length of played contents up to now. A section displayed with a white color indicates the length of remaining contents. The full length of the progressive bar indicates a full running time of the contents.

When a user taps (406) a right side of the handler button 404, the processor 130 rapidly plays the contents. The processor 130 rapidly plays the contents at a preset time interval speed. For example, each time tap occurs, the processor 130 rapidly plays the contents while moving a playback location for each one second in a forward direction. If the user taps a left side of the handler button 404, the processor 130 plays the contents rapidly and reversely at a preset time interval, i.e., one second. While the touch is maintained at a certain location of the bar, the processor 130 rapidly moves the contents in a forward and backward direction. For example, if a touch occurs for 10 seconds at the same location 406 on the progressive bar, the processor 130 determines that tap is repeatedly input for 10 seconds, and moves a playback location of the contents while rapidly forwarding the contents to where the touch is maintained. If a drag operation occurs on the progressive bar, the processor 130 slowly plays the contents. Here, the processor 130 plays the contents in a forward or backward direction according to speed and a direction of dragging. If the user drags an upper part of the progressive bar to a right side, the processor 130 slowly plays the contents in a forward direction. If the user drags an upper part of the progressive bar to a left side, the processor 130 slowly plays the contents in a backward direction.

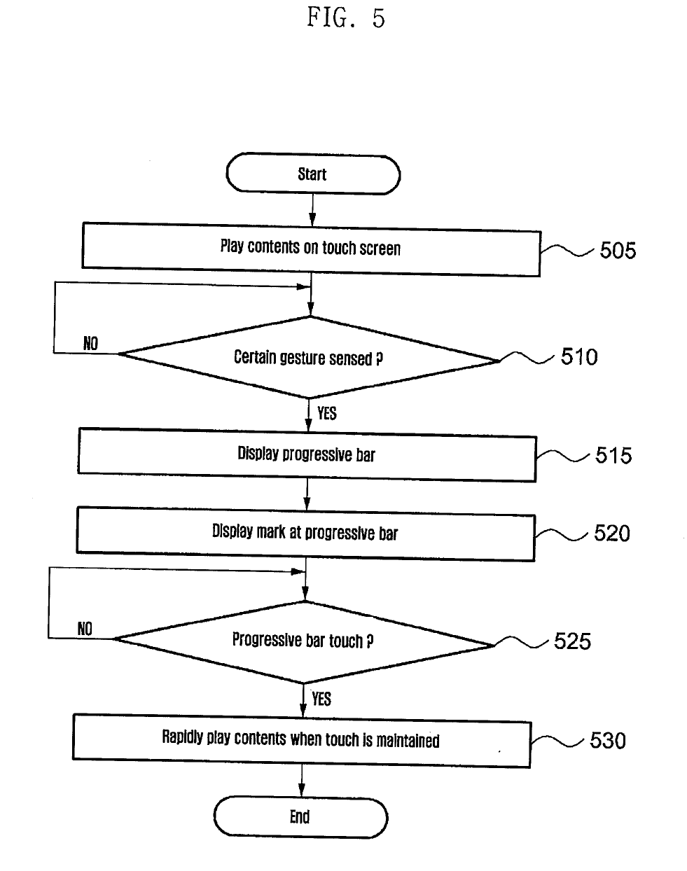

Hereinafter, the operation process of different embodiments are illustrated in the following FIGS. 5 through 7.

FIG. 5 is a flowchart illustrating a method for processing gesture input during a playback of contents according to an embodiment of the present invention.

Referring to FIG. 5, contents are played on a touch screen (505). To play the contents, the processor 130 controls a portable electronic device to decodes and display the contents on a touch screen. The contents may include, but not limited to, moving image files, music files, slide show files configured by photographs, and E-book files. The contents are time-based contents, thus a played location of which is changed according to elapse of time. That is, as time elapses, a screen is converted to display the time-based contents on the touch screen.

The processor 130 determines whether a certain gesture occurring on the touch screen 120 is sensed during a playback of the contents (510). If the gesture is input, the processor 130 compares the input gesture with a preset gesture stored in the memory 110 of FIG. 1. When the input gesture is identical with the preset gesture stored in the memory 110, the processor performs a step 515.

The processor 130 displays a progressive bar having information regarding a running time of the contents played on the touch screen to overlap with the contents in response to the certain gesture (515). In an exemplary embodiment, the processor 130 displays a progressive bar at a lower end of the touch screen. The length of the progressive bar is substantially identical with a width of the touch screen. For example, when the width of the touch screen is 70 mm, a width of contents displayed on the touch screen and a width of the progressive bar may be 70 mm. The width of the progressive bar displayed on the touch screen may be smaller than 70 mm in a degree. Because the progressive bar is displayed during a playback of the contents, the contents may be displayed to occupy a minimal region of the touch screen so as not to hinder a user from viewing the contents.

The thickness of the progressive bar is sufficiently reduced such that the progressive bar may be displayed as a line. The progressive bar may be displayed to overlap with the contents so as not to hinder the user from viewing the contents. The full length of the progressive bar may correspond to a total running time of the contents. For example, when the total running time of the contents is 120 minutes, the full length of the progressive bar is also 120 minutes. When the total running time of the contents is 60 minutes, the full length of the progressive bar is also 60 minutes.

The processor 139 may display a book mark at a location of the progressive bar corresponding to an occurrence time point of the certain gesture (520). That is, the processor 130 may determine a location of the progressive bar corresponding to an occurrence time point of the certain gesture based on information about a running time of the contents, and display the mark at a location of the progressive bar corresponding to an occurrence time point of the certain gesture. For example, when the total running time of the contents is 120 minutes, the full length of the progressive bar is also 120 minutes. If a gesture detected during a playback of the contents is identical to a predefined gesture stored in the memory 110 of FIG. 1, the processor 130 calculates a time point when the certain gesture occurs. When the occurrence time point of the certain gesture is a time point after 20 minutes elapse from start of playback of the contents, the processor 130 displays a mark at a location corresponding to 20 minutes in the full length of the progressive bar. If a gesture of the “V” shape is detected on a region of the touch screen 120 on which the contents are displayed during a playback of the contents, the processor 130 displays the mark at a corresponding location of the progressive bar. A delay time for performing a corresponding operation may occur. As such, the mark may be displayed at a location corresponding to a time earlier to compensate the operation delay. For example, if it takes 30 ms for the processor 130 to recognize and process the gesture, the processor 130 calculates that the occurrence time of the gesture is 30 ms prior, and c displays the mark earlier by the calculated duration on a progressive bar to compensate for the calculation delay. Thus, if a gesture of “V” shape occurs after 20 minutes elapses from start of a playback of the contents, although a time point recognizing the gesture of “V” shape by the processor 130 is 20 minutes and 0.3 second, the processor 130 may display a mark at a location of 20 minutes of the progressive bar in consideration of a delay time having 30 ms.

An indicator indicating a current played location of the contents is displayed on the progressive bar. The indicator moves on the progressive bar in response to playback of the contents. The indicator is firstly located at the leftmost part of the progressive bar. If the contents are played, the indicator moves to a right side of the progressive bar proportional to the playback speed of the contents. A handler button 216 of FIG. 2 is the indicator.

The processor 130 checks whether a touch is sensed on the progressive bar (525). If the touch is sensed on the progressive bar and the touch duration is maintained for a preset time period, the processor 130 may rapidly play the contents (530). Further, if the sensed location of the touch is a right side of the indicator, the processor 130 rapidly plays the contents at a predetermined time interval or forwardly skips the contents. Conversely, if the sensed location of the touch is a left side of the indicator, the processor 130 rapidly plays the contents at a predetermined time interval in a reverse direction.

The processor 130 determines that tap operation occurs within a predetermined time period. Each time the tap occurs, the processor 130 rapidly plays the contents while advancing a playback location by one second for each tap forwardly or reversely.

If the touch continuously occurs in the same location on the progressive bar for a predefined time period, the processor 130 rapidly moves the contents in a forward or backward direction for the duration of the touch. For example, if the touch occurs at the same location on the progressive bar for 10 seconds, the processor 130 determines that the tap is repeatedly input for 10 seconds, and rapidly advances the contents during the 10 second period.

Furthermore, when the contents are a moving image or a music file, the processor 130 plays the contents while advancing the content in units of predetermined times. When the contents are an E-book, the processor 130 plays the contents in units of predetermined pages. For example, when the contents are the moving image, each time the user taps the progressive bar, the processor 130 plays and advances the contents either in a forward or backward direction by a predetermined amount. When the contents are configured by plural pages such as an E-book, each time the user taps an upper part of the progressive bar, the processor 130 may move each page at a time.

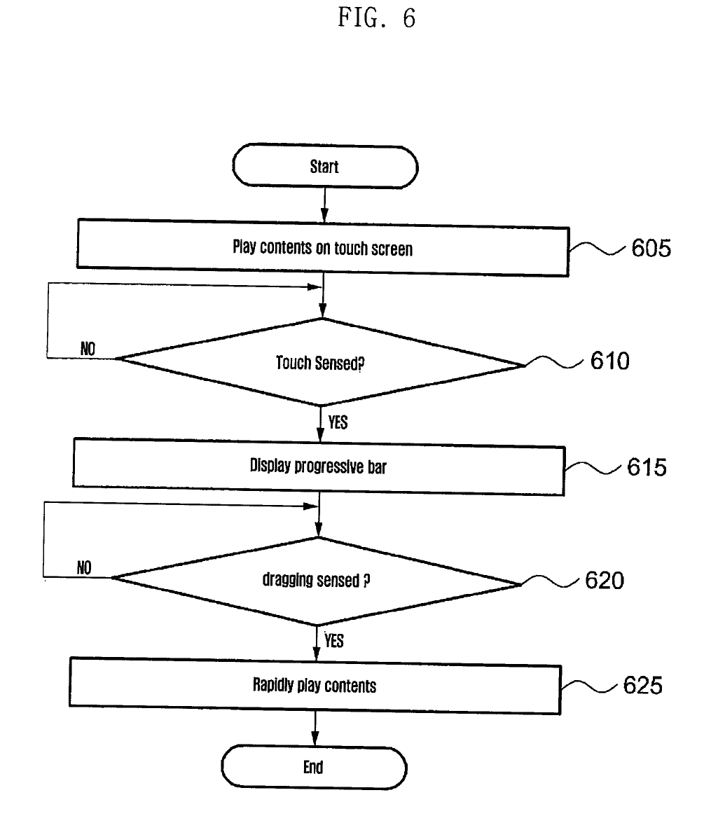

FIG. 6 is a flowchart illustrating a method for processing dragging during playback of contents according to another embodiment of the present invention.

If contents are played on a touch screen 120, they are displayed on the touch screen 120 (605). The played contents may be time-based contents. To play the contents, the processor 130 controls a portable electronic device to decode and display the contents on the touch screen 120. The processor 130 senses a touch occurring on the touch screen 120 displaying the contents during a playback of the contents (610).

The touch screen may be divided into a contents display region displaying contents and a control region controlling a playback of the contents. Alternatively, the contents display region and the control region may be the same region. Also, the control region may be hidden while the contents are being displayed. If a touch is sensed on a touch screening displaying the contents, the processor 130 displays the progressive bar in the control region. The processor 130 displays a progressive bar having information about a running time of the contents to overlap with the contents (615). If the progressive bar is displayed on the touch screen for a predetermined time period and there is no additional input from a user, the progressive bar automatically disappears. Further, when a touch is sensed during playback of the contents, the processor 130 displays a guide message of FIG. 2 on the touch screen.

The length of the progressive bar corresponds to a total running time of the contents. The length of the progressive bar is substantially identical with a full length of the contents. When a running time of the contents is 120 minutes, the full length of the progressive bar represents a duration of 120 minutes.

If dragging is senses based on the occurrence location of the touch (620), the processor 130 controls a playback location of the contents corresponding to a direction and speed of the dragging (625). If the touch occurs and dragging occurs in a right direction, the processor rapidly plays the contents in a forward direction. While a dragging motion is detected, the contents are rapidly played according the speed and direction thereof. For example, if the user slowly drags the touch screen in a right direction, the contents are played at 2.5 times of the normal speed. If the user rapidly drags the touch screen in a right direction, the contents may be played at twice of the normal speed. If the dragging is terminated, the processor 130 plays the contents at the controller playback location.

Meanwhile, if the processor 130 senses a certain gesture occurring on the touch screen during playback of the contents, the processor 130 checks whether a gesture is input from the touch screen while the contents are being played. Here, if the gesture is input, the processor 130 compares the input gesture with a preset gesture stored in a memory 110 of FIG. 1. If it is determined that the input gesture is identical with the stored preset gesture, the processor 130 performs a corresponding operation. The processor 130 may display a mark at a location of the progressive bar corresponding to an occurrence time point of the certain gesture.

For example, if a total running time of the contents is 120 minutes, the length of the progressive bar also becomes 120 minutes. If it is determined that a gesture detected during a playback of the contents is identical with a certain gesture stored in the memory 110 of FIG. 1, the processor 130 calculates the occurrence time point of the certain gesture. When the occurrence time point of the certain gesture is a time point after 20 minutes elapses from start of playback of the contents, the processor 130 displays a book mark to a location of a full length of the progressive bar corresponding to 20 minutes.

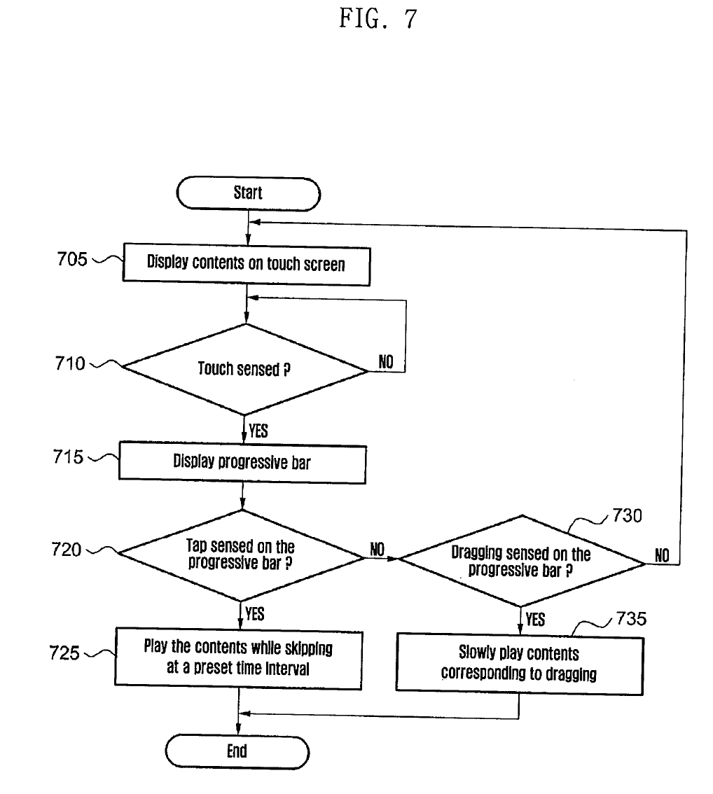

FIG. 7 is a flowchart illustrating a method for processing tag operation and dragging occurring on a progressive bar according to still another embodiment of the present invention.

Referring to FIG. 7, contents are displayed on a touch screen 120 (705). If a touch is sensed while the contents are being displayed on the to touch screen 120 (710), a progressive bar is displayed on the touch screen 120 (715). A processor 130 determines whether a tap is sensed on the progressive bar in a displayed state of the progressive bar (720). If the tap is sensed, the processor 130 rapidly plays the contents while skipping the content at a preset time interval (725).

Further, if dragging is sensed on the progressive bar (730), the processor 130 slowly plays the contents corresponding to the dragging motion (735). If the dragging occurs, the processor 130 checks an occurrence region of the dragging. If the dragging occurs on a contents display region, the processor 130 rapidly plays the contents in a forward or backward direction while skipping the contents. If the dragging occurs on the progressive bar, the processor 130 slowly plays the contents corresponding to the speed and direction of the dragging operation. For example, if the dragging occurs in a right direction on the progressive bar, the processor slowly plays the contents in a forward direction at 0.7 times of the normal speed. Conversely, if the dragging occurs in a left direction on the progressive bar, the processor 130 slowly plays the contents at 0.7 times of the normal speed in a reverse direction. By a function playing the contents in a forward or receive direction with speed slower than normal speed, the user may minutely control a playback location.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM; ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail herein, it should be clearly understood that many variations and modifications of the basic inventive concepts herein taught which may appear to those skilled in the present art will still fall within the spirit and scope of the present invention, as defined in the appended claims.

What is claimed is:

1. A method for replaying a content in a portable electronic device having a touch screen, the method comprising:
sensing a touch event occurring on the touch screen during a playback of the content;
displaying a progressive bar having information regarding a running time of the content currently displayed on the touch screen in response to the touch event; and
determining a location on the progressive bar corresponding to the currently displayed content when the touch event occurs and displaying an indicator at the determined location.

2. The method of claim 1, wherein displaying the indicator comprises displaying the indicator in front of the determined location by a preset time amount.

3. The method of claim 1, further comprising:
displaying a mark indicating a current played location of the content on the progressive bar in response to a predetermined gesture sensed on the touch screen for a subsequent replay purpose.

4. The method of claim 1, further comprising:
playing the content while forwardly skipping the content at a preset time interval when a new touch is sensed at a right side of the indicator; and
reversely playing the content while skipping the content at the preset time interval when a new touch is sensed at a left side of the indicator.

5. The method of claim 1, when a new touch is sensed more than a predefined time period on the progressive bar, continuously skipping the content at the preset time interval until the content corresponding to the location of the new touch is reached.

6. The method of claim 5, further comprising:
playing the content at a normal speed after the content corresponding to the location of the new touch is reached.

7. The method of claim 3, further comprising:
controlling a playback location of the contents to a playback location on which the mark is displayed when a touch occurs on the mark.

8. The method of claim 1, further comprising:
in response to detecting a dragging motion on the touch screen, controlling a played location of the content corresponding to a direction and speed of the dragging motion; and
playing the content at the controlled played location when the dragging motion is terminated.

9. The method of claim 1, further comprising:
controlling a playback speed of the content corresponding to a dragging motion sensed on the progressive bar; and
playing the content at a normal speed when the dragging motion is terminated.

10. The method of claim 1, further comprising:
displaying a guide message associated with the content in response to the touch event.

11. An apparatus for playing contents, comprising:
a touch screen playing contents on a screen; and
a processor sensing a touch event on the touch screen during a playback of the contents, displaying a progressive bar having information regarding running time of the contents currently displayed on the touch screen in response to the touch event, and controlling a display of an indicator at a location of the progressive bar corresponding to an occurrence time point of the touch event.

12. The apparatus of claim 11, wherein the processor displays the indicator at a location in front of the location corresponding to an occurrence time point of the touch event by a preset time amount.

13. The apparatus of claim 11, wherein the touch screen displays a mark indicating a current played location of the contents on the progressive bar in response to a predetermined gesture sensed on the touch screen for a subsequent replay.

14. The apparatus of claim 11, wherein the processor plays the contents while skipping the contents at a preset time interval when a new touch is sensed at a right side of the indicator; and reversely plays the contents while skipping the contents at the preset time interval when the new touch is sensed at a left side of the indicator.

15. The apparatus of claim 11, wherein the processor controls a playback location of the contents to a playback location on which the mark is displayed when a touch occurs on the mark.

16. The apparatus of claim 11, wherein the processor plays the contents while skipping the contents corresponding to the direction and speed of a dragging motion sensed on the touch screen, and plays the contents at a normal speed when the dragging motion is terminated.

17. The apparatus of claim 16, wherein the processor displays an indicator indicating a current played location of the contents on the progressive bar, and plays the contents while skipping the contents at a preset time interval when tap is sensed on the progressive bar.

18. The apparatus of claim 11, wherein the processor slowly plays the contents corresponding to dragging when the dragging is sensed on the progressive bar.

19. The apparatus of claim 11, further comprising:
displaying a guide message associated with the content in response to the touch event.
